(19) United States
(12) Patent Application Publication
(10) Pub. No.: US 2026/0352519 A1
(43) Pub. Date: Nov. 5, 2026

(54) APPARATUSES AND METHODS FOR SLOT-WISE CHANNEL PREDICTION AND SIGNALLING

(71) Applicant: Nokia Technologies Oy, Espoo (FI)

(72) Inventors: Elias Aksel RANINEN, Espoo (FI); Dani Johannes KORPI, Helsinki (FI)

(73) Assignee: Nokia Technologies Oy, Espoo (FI)

(21) Appl. No.: 19/478,346

(22) PCT Filed: Apr. 28, 2023
(86) PCT No.: PCT/EP2023/061378

§ 371 Date: Oct. 24, 2025

(51) Int. Cl. H04L 25/02; H04L 5/00; H04W 72/1273

(52) U.S. Cl. CPC H04L 25/0232; H04L 5/0048; H04W 72/1273

(57) ABSTRACT

Example embodiments provide a method to reduce pilot symbols sent by a user node to a network node in transmission time intervals. In an example embodiment, an apparatus may be configured to determine at least one indication of channel prediction accuracy based on received data from a user node during transmission time intervals comprising a set of pilot symbols; determine that transmission of the set of pilot symbols from the user node can be reduced based on the at least one indication of channel prediction accuracy; send, to the client node, a message comprising instructions to at least reduce the number of pilot symbols in one or more -arappAtransmission time intervals transmitted between every πth transmission time interval, wherein π is an integer greater than one. tuses, methods, and computer programs are disclosed.

### TECHNICAL FIELD

The present application generally relates to information technology. Some example embodiments of the present application relate to slot-wise channel prediction and signalling, for example, for orthogonal frequency division multiplexing (OFDM) receivers.

### BACKGROUND

During OFDM transmissions, a transmitter may send a message to a receiver via a wireless channel. For the receiver to successfully decode the message, an accurate channel estimation may be needed due to distortions caused on the message while propagating through the wireless channel. It would be beneficial to provide improvements for the channel estimation process while reducing the reference signal overhead.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable reduction in reference signal overhead via reducing pilot transmissions based on channel prediction accuracy. This may be achieved by the features of the independent claims. Further implementation forms are provided in the dependent claims, the description, and the drawings.

According to a first aspect, an apparatus may comprise at least one processor; and at least one memory including instructions which, when executed by the at least one processor, cause the apparatus at least to: perform, upon receiving transmission time intervals comprising a set of pilot symbols from a user node, a channel estimate of the received transmission time interval and channel predictions for one or more subsequent transmission time intervals based on the set of pilot symbols; determine at least one indication of channel prediction accuracy based on the channel estimates and channel predictions; determine that transmission of the set of pilot symbols from the user node can be reduced based on a set threshold specific for each of the at least one indication of channel prediction accuracy; send, to the user node, a message comprising instructions to at least reduce pilot symbols transmitted between every nth transmission time interval, wherein n is an integer greater than one.

According to an example embodiment of the first aspect, the message may comprise instructions to disable transmission of the set of pilot symbols between every nth transmission time interval or to transmit reduced pilot patterns between every nth transmission time interval.

According to an example embodiment of the first aspect, the instructions may be sent in a downlink control information message for scheduling grant.

According to an example embodiment of the first aspect, the integer n is determined based on the one or more indications of channel prediction accuracy of the one or more subsequent transmission time intervals.

According to an example embodiment of the first aspect, the at least one memory further includes instructions which, when executed by the at least one processor, cause the apparatus to: monitor the at least one indication of channel prediction accuracy after sending the message to the user node; detect degradation in the channel prediction accuracy based on a comparison of a latest channel estimation and the channel prediction of a current transmission time interval; send, to the user node, a message comprising instructions to transmit the set of pilot symbols during each transmission time interval.

According to an example embodiment of the first aspect, obtain a raw channel estimate based on the set of received pilot symbols in a transmission time interval for input to a neural network trained for channel predictions; obtain the channel predictions for the one or more subsequent transmission time intervals based on an output from the neural network; and perform interpolation or extrapolation on the output to estimate the channel for the one or more subsequent transmission time intervals over a resource grid.

According to an example embodiment of the first aspect, the at least one memory comprises instructions which, when executed by the at least one processor, cause the apparatus to: perform demodulation based on the channel estimate for every nth received transmission time interval comprising the set of pilot symbols; and perform demodulation based on the channel prediction for the one or more subsequent transmission time intervals received between every nth transmission time interval.

According to an example embodiment of the first aspect, the at least one memory further comprises instructions which, when executed by the at least one processor, cause the apparatus to: calculate a block error rate of a received nth transmission time interval from the user node comprising the set of pilot symbols based on the channel estimation; calculate a block error rate of a transmission time interval received from the user node between the every nth transmission time interval based on the channel prediction; and send a message to the user node comprising instructions to reduce the value of n or send the set of pilot symbols in each transmission time interval when a difference between the block error rates exceeds the threshold set for the difference.

According to an example embodiment of the first aspect, the at least one memory comprises instructions which, when executed by the at least one processor, cause the apparatus to: obtain coefficients of the channel prediction and coefficients of the channel estimate of the current transmission time interval; and send the message comprising instructions to send the set of pilot symbols in each transmission time interval or to reduce the pilot symbols based on a distance measure between the predicted and estimated coefficients and the threshold set for the distance measure.

According to a second aspect, an apparatus may comprise at least one processor; and at least one memory including instructions which, when executed by the at least one processor, cause the apparatus at least to: transmit data to a network node in transmission time intervals comprising a set of pilot symbols; receive, from the network node, a message comprising instructions to at least reduce the pilot symbols in one or more transmission time intervals transmitted between every nth transmission time interval, wherein n is an integer greater than one; and transmit the pilot symbols to the network node according to the instructions.

According to an example embodiment of the second aspect, the message comprises instructions to disable transmission of the pilot symbols between every nth transmission time interval or to transmit reduced pilot patterns between every nth transmission time interval.

According to an example embodiment of the second aspect, the instructions are sent in a downlink control information message for scheduling grant.

According to an example embodiment of the second aspect, the at least one memory further comprises instructions which, when executed by the at least one processor, cause the apparatus to: receive, from the network node, a message comprising instructions to transmit the set of pilot symbols in every transmission time interval; and transmit the set of pilot symbols to the network node according to the latest instructions.

According to a third aspect, a computer-implemented method may comprise performing, upon receiving transmission time intervals comprising a set of pilot symbols from a user node, a channel estimate of the received transmission time interval and channel predictions for one or more subsequent transmission time intervals based on the set of pilot symbols; determining at least one indication of channel prediction accuracy based on the channel estimate and channel prediction for a respective transmission time interval; determining that transmission of the set of pilot symbols from the user node can be reduced based on a set threshold specific for each of the at least one indication of channel prediction accuracy; sending, to the user node, a message comprising instructions to at least reduce pilot symbols transmitted between every nth transmission time interval, wherein n is an integer greater than one.

According to an example embodiment of the third aspect, the message may comprise instructions to disable transmission of the set of pilot symbols between every nth transmission time interval or to transmit reduced pilot patterns between every nth transmission time interval.

According to an example embodiment of the third aspect, the instructions may be sent in a downlink control information message for scheduling grant.

According to an example embodiment of the third aspect, the integer n is determined based on the at least one indication of a prediction accuracy for the one or more subsequent transmission time intervals.

According to an example embodiment of the third aspect, the method may comprise monitoring the at least one indication of channel prediction accuracy after sending the message to the user node; detecting degradation in the channel prediction accuracy based on a comparison of a latest channel estimation and the channel prediction of a current transmission time interval; and sending, to the user node, a message comprising instructions to transmit the set of pilot symbols during each transmission time interval.

According to an example embodiment of the third aspect, the method may comprise obtaining a raw channel estimate based on the set of received pilot symbols in a transmission time interval for input to a neural network trained for channel predictions; obtain the channel predictions for the one or more subsequent transmission time intervals based on an output from the neural network; and performing interpolation or extrapolation on the output to estimate the channel for the one or more subsequent transmission time intervals over a resource grid.

According to an example embodiment of the third aspect, the method may comprise performing demodulation based on the channel estimate for every nth transmission time interval received form the user node comprising the set of pilot symbols; and performing demodulation based on the channel prediction for the one or more transmission time intervals received from the user node between every nth transmission time interval.

According to an example embodiment of the third aspect, the method may comprise calculating a block error rate of a received nth transmission time interval comprising the set of pilot symbols based on the channel estimation; calculating a block error rate of a transmission time interval received between the every nth transmission time intervals based on the channel prediction; and sending a message to the user node comprising instructions to reduce the value of n or send the set of pilot symbols in each transmission time interval when a difference between the block error rates exceeds a predefined threshold.

According to an example embodiment of the third aspect, the method may comprise obtaining coefficients of the channel prediction and coefficients of the channel estimate of the current transmission time interval; and sending the message comprising instructions to reduce the pilot symbols or to send pilot symbols in each transmission time interval based on a distance measure between the coefficients and a threshold set for the distance measure.

According to a fourth aspect, a computer-implemented method may comprise transmitting data to a network node in transmission time intervals comprising a set of pilot symbols; receiving, from the network node, a message comprising instructions to at least reduce the pilot symbols in one or more transmission time intervals transmitted between every nth transmission time interval, wherein n is an integer; and transmitting the pilot symbols to the network node according to the instructions.

According to an example embodiment of the fourth aspect, the message comprises instructions to disable transmission of the pilot symbols between every nth transmission time interval or to transmit reduced pilot patterns between every nth transmission time interval.

According to an example embodiment of the fourth aspect, the instructions are sent in a downlink control information message for scheduling grant.

According to an example embodiment of the fourth aspect, the method comprises receiving, from the network node, a message comprising instructions to transmit the set of pilot symbols in every transmission time interval; and transmitting the set of pilot symbols to the network node according to the latest instructions.

According to a fifth aspect, a computer program may be configured, when executed by a processor, to cause an apparatus at least to perform the following: perform, upon receiving transmission time intervals comprising a set of pilot symbols from a user node, a channel estimate of the received transmission time interval and channel predictions for one or more subsequent transmission time intervals based on the set of pilot symbols; determine at least one indication of channel prediction accuracy based on the channel estimates and channel predictions; determine that transmission of the set of pilot symbols from the user node can be reduced based on a set threshold specific for each of the at least one channel prediction accuracy; send, to the user node, a message comprising instructions to at least reduce pilot symbols transmitted between every nth transmission time interval, wherein n is an integer greater than one. The computer program may further comprise instructions for causing the apparatus to perform any example embodiment of the method of the third aspect.

According to a sixth aspect, an apparatus may comprise means for performing, upon receiving transmission time intervals comprising a set of pilot symbols from a user node, a channel estimate of the received transmission time interval and channel predictions for one or more subsequent transmission time intervals based on the set of pilot symbols; determining at least one channel prediction accuracy based on the channel estimates and channel predictions; determining that transmission of the set of pilot symbols from the user node can be reduced based on a set threshold specific for each of the at least one channel prediction accuracy; and sending, to the user node, a message comprising instructions to at least reduce pilot symbols transmitted between every nth transmission time interval, wherein n is an integer greater than one. The apparatus may further comprise means for performing any example embodiment of the method of the third aspect.

According to a seventh aspect, a computer program may comprise instructions for causing an apparatus to perform at least the following: transmit data to a network node in transmission time intervals comprising a set of pilot symbols; receive, from the network node, a message comprising instructions to at least reduce the pilot symbols in one or more transmission time intervals transmitted between every nth transmission time interval, wherein n is an integer greater than one; and transmit the pilot symbols to the network node according to the instructions. The computer program may further comprise instructions for causing the apparatus to perform any example embodiment of the method of the fourth aspect.

According to an eighth aspect, an apparatus may comprise means for transmitting data to a network node in transmission time intervals comprising a set of pilot symbols; receiving, from the network node, a message comprising instructions to at least reduce the pilot symbols in one or more transmission time intervals transmitted between every nth transmission time interval, wherein n is an integer greater than one; and transmitting the pilot symbols to the network node according to the instructions. The apparatus may further comprise means for performing any example embodiment of the method of the fourth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a communication system comprising network nodes and a client node according to an example embodiment.

FIG. 2 illustrates an example of an apparatus configured to practice one or more example embodiments;

FIG. 3 illustrates an example of a communication system configured to perform channel predictions, according to an example embodiment;

FIG. 4 illustrates an example of bit error rates obtained with channel predictions compared to baselines according to an example embodiment;

FIG. 5 illustrates an example flow chart for enabling reduction of reference signals based on channel predictions by a base station, according to an example embodiment;

FIG. 6 illustrates an example flow chart for performing a corrective action based on tracked channel prediction accuracy by a base station, according to an example embodiment;

FIG. 7 illustrates an example of a message sequence chart between a client node and a base station for reduction of reference signals according to an example embodiment;

FIG. 8 illustrates an example of a method for managing reduction of reference signals to be sent by a user node according to an example embodiment;

FIG. 9 illustrates an example of a method for reduction of reference signals sent by a user node according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

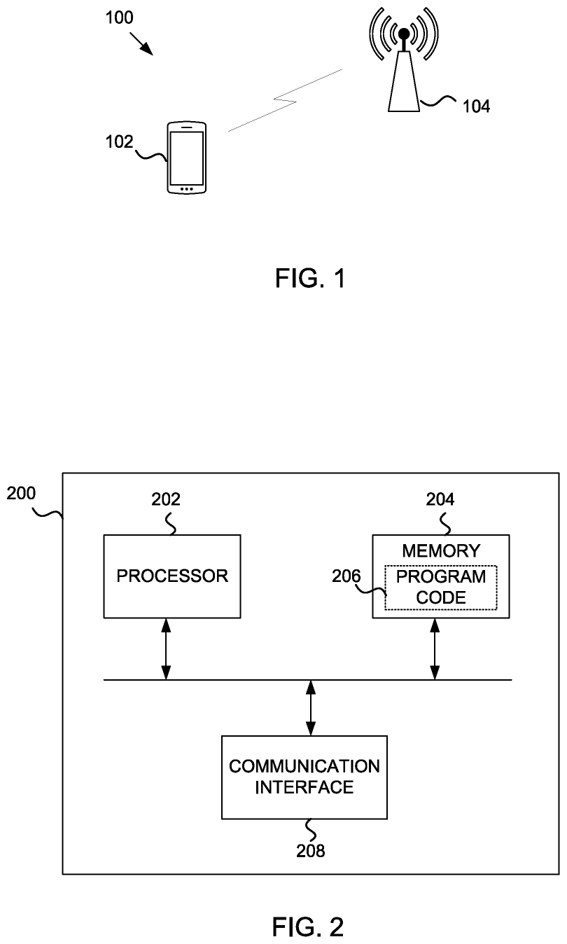

FIG. 1 illustrates an example of a communication system 100 according to an example embodiment. The communication system 100 may comprise a client node, such as user equipment (UE) 102, and a network node, such as a base station (BS). A UE may be also called a user node. The base station may be, for example, a gNB 104. The UE 102 and the gNB 104 may be configured to communicate via one or more channels. Communications between a UE and a gNB may be bidirectional. Hence, any of the devices may be configured to operate as a transmitter and/or a receiver. Although depicted as a single device, a base station may not be a stand-alone device, but for example a distributed computing system coupled to a remote radio head. A channel may refer either to a physical transmission medium such as a wire, or to a logical connection over a multiplexed medium such as a wireless radio channel.

The communication system 100 may be configured for example in accordance with the 5th Generation digital cellular communication network, as defined by the 3rd Generation Partnership Project (3GPP). In one example, the communication system 100 may operate according to 3GPP 5G-NR. It is however appreciated that example embodiments presented herein are not limited to this example system and may be applied in any present or future wireless or wired communication systems, or combinations thereof, for example other type of cellular systems, short-range wireless systems, broadcast or multicast systems, or the like.

The UE 102 may be configured to send data to the gNB 104 in an OFDM uplink transmission. OFDM is the main waveform used in 5G NR. Advantages of OFDM include that it may be robust to frequency selective channels, and thus simplifies equalizer design as well as enables high data rates. In OFDM transmission, data symbols, represented by complex numbers, are mapped to resource elements in a resource grid, which is a time-frequency representation of a transmitted signal. The time axis of the resource grid may be in units of OFDM symbols, and the corresponding frequency axis may be in units of subcarriers. For example, if the duration of an OFDM symbol is T seconds, then the subcarrier spacing is 1/T Hertz. Before the transmission, an inverse discrete Fourier transform (IDFT) may be applied to the OFDM symbol, and a cyclic prefix (CP) may be added by the UE. The CP may simplify receiver processing by mitigating inter-symbol interference (ISI) as well as enabling the communication channel 106 to be treated as a circular convolution with the transmitted signal. As the transmitted signal propagates through a wireless channel, it may get distorted due to various channel effects, such as multipath, scattering, doppler, as well as large and small-scale fading. For a receiver, such as the gNB, to decode the transmitted signal, the channel distortions need to be estimated, and their effects need to be reversed. Channel estimation is therefore an important processing step at the receiver, whose successfulness may determine the performance of the whole communication system 100.

In a dynamic environment, channel conditions may be under constant change, and for a BS to reliably decode the information transmitted by a UE, channel state information (CSI) may be needed. The UE may be configured to send a sequence of pilot symbols, which are known a priori at the BS and can be used for estimating the CSI by the BS. Once the BS has obtained an accurate estimate of the channel, the transmitted message can be successfully decoded.

In 5G NR, the information may be sent in transmission time intervals (TTIs), also called slots. For example, one or more consecutive slots allocated to either DL (downlink) or UL (uplink) may make up a TTI. A TTI may consist of, for example, 14 OFDM symbols. A TTI may incorporate a set of pilot symbols such as demodulation reference signals (DMRS) in 5G NR. Pilot symbols may be also referred to as pilot signals or pilots. The pilot symbols may occupy several resource elements of a resource grid, and hence, reduce the overall efficiency of a communication link. The less pilot symbols need to be transmitted, the higher data rates can be obtained, as the information can be more efficiently transmitted.

For example, one of antennas of the gNB 104 may have received from the UE 102 one TTI or slot of data comprising N_{OFDM} OFDM symbols and N_{FFT} subcarriers. In OFDM systems, before further processing, time-domain signals (corresponding to OFDM symbols) may be first transformed to frequency domain by removing the CP and applying the discrete Fourier transform (DFT). Then, the received data can be represented in a resource grid, whose resource elements are given by:

yᵢⱼ=hᵢⱼxᵢⱼ+nᵢⱼ∈ [symbol] , i=1, . . . ,N_{OFDM}, j=1, . . . ,N_{FFT}, (1)

where yᵢⱼ is the received data, hᵢⱼ is the unknown channel coefficient, xᵢⱼ is the sent data symbol, nil is (circularly symmetric) zero mean complex Gaussian noise, and the subscripts i and j refer to OFDM symbol i and subcarrier j, respectively. The gNB 104 may be configured to estimate the data symbols xᵢⱼ, for all i,j. The gNB 104 may first need to obtain channel coefficients hᵢⱼ. In a OFDM transmission, a fraction of the resource elements in the resource grid may be allocated for pilot symbols to facilitate channel estimation at the receiver. Pilot symbols can be distributed in different ways in the resource grid. For example, in a TTI the pilot symbols may be located at OFDM symbol indices 2 and 11 and spanning through subcarrier indices 6-58.

From the TTI received by the one or more antennas of the gNB 104, the resource elements corresponding to the pilot symbols may be collected into the vector y defined by

y=h∘p+n∈ [symbol] ,

where ∘ denotes element-wise product, h denotes (unknown) channel coefficients, p denotes (known) pilot symbols, n denotes zero mean (circularly symmetric) Gaussian noise, and Nₚ denotes the number of pilot symbols. Raw channel estimates (in the least-square sense) may be obtained by

ĥ_{raw}=y∅p (2)

where ∅ denotes element-wise division. Based on the raw channel estimates, the gNB 104 may be further configured to predict the channel h corresponding to subsequent TTIs.

In channel prediction, an objective is to predict the future channel state based on previous channel estimates. In highly time-varying channel conditions, the current CSI at a transceiver may have already become outdated when it is needed in a signal processing block, thus leading to inferior performance. Channel prediction may be especially important in frequency-division duplex (FDD) systems, where the communication channel is different for uplink and downlink, i.e., it is not reciprocal. Therefore, in FDD the CSI may need to be first be estimated at the receiver and then sent back to the transmitter, thus creating a feedback delay that can result in channel aging. Also, in time-division duplex (TDD), channel prediction may be needed in the case when the pilot symbols are transmitted only for the first couple of OFDM symbols in a slot and may become outdated for the last remaining OFDM symbols in the slot.

An objective of this disclosure is to reduce the overhead caused by pilot symbols. The overhead reduction may be achieved, for example, by using an adaptive channel prediction scheme in an OFDM uplink transmission scenario. According to an example embodiment, a method for identifying when channel prediction can be used by a base station instead of pilot-based channel estimation is provided. In addition, a neural network-based method for channel prediction is described.

Due to dynamic channel conditions, channel prediction may not always be workable. In such case, it may be beneficial to re-start channel estimation with pilot symbols to ensure quality of channel state. In an example embodiment, a BS may be configured to instruct a UE how and/or when to transmit pilot symbols. The instructions may be based on one or more indications of prediction accuracy monitored by the BS. The one or more indications may be based on, for example, comparison of block error rates or coefficients for predicted and estimated channels. For example, the BS may be configured to determine when the transmission of pilot symbols may be reduced based on the indication of prediction accuracy being above or below a specific threshold set for the indication.

There are several possibilities of how to technically implement the signalling between a UE and a gNB to reduce the number of transmitter pilot symbols. For example, identification of the situation where the gNB may not need all the pilot symbols for every TTI could be implemented by calculating a loss function, which estimates how well the channel can be predicted. By monitoring the value of this loss function by the gNB, signalling the instructions to the UE to send the pilot symbols for every nth TTI may be executed when the loss function reaches a value below a predetermined threshold. For channel estimation and prediction, different algorithms and methods can be used, including neural network (NN) based prediction.

Advantages of example embodiments may comprise achieving reduction in reference signal (RS) overhead via switching off pilot transmission when possible, based on an estimation performed by a gNB. In addition, the use of channel prediction and RS overhead reduction may be implemented in a versatile and adaptive manner via agreed decision logic and signaling between a client node and a network node.

FIG. 2 illustrates an example of an apparatus 200 configured to practice one or more example embodiments.

The apparatus 200 may comprise at least one processor 202. The at least one processor 202 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The memory 204 may be configured to store, for example, computer program code 206 or the like, for example operating system software and application software. The memory 204 may comprise one or more volatile memory devices, one or more non-volatile memory devices, and/or a combination thereof. For example, the memory 204 may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise one or more transceivers 208 configured to enable the apparatus 200 to transmit information to other devices and/or receive information from other devices. The transceiver 208 may be configured to provide at least one wireless radio connection, such as for example a 3GPP mobile broadband connection (e.g. 3G, 4G, 5G). However, the transceiver may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The transceiver 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

When the apparatus 200 is configured to implement some functionality, some component and/or components of the apparatus 200, such as for example the at least one processor 202 and/or the memory 204, may be configured to implement this functionality. Furthermore, when the at least one processor 202 is configured to implement some functionality, this functionality may be implemented using program code 206 comprised, for example, in the memory 204.

In an example embodiment, the apparatus 200 may comprise a base station, such as the gNB 104, configured to receive several TTIs of data from a UE. The apparatus 200 may be configured to identify a situation, where it may not need pilots for each TTI from the UE. In response to the identified situation, the apparatus 200 may be configured to signal the UE to send pilot symbols, for example, only for every nth TTI or with a reduced pilot pattern between every nth TTI. n may be a positive integer greater than one. A reduced pilot pattern may be also referred to as a sparse pilot pattern. For example, the UE may be configured to transmit all configured pilot symbols at every nth TTI, and only some of the pilot symbols between the every nth TTI. For example, if n=3, the UE could send a full set of pilot symbols during the third TTI and every second or every third pilot symbol from the full set of pilot symbols during the first and the second TTI. The apparatus 200 may be configured to use the pilot symbols of every nth TTI to predict the channel for the subsequent n−1 TTIs.

In an example embodiment, the apparatus 200 may comprise a user node, such as the UE 102, configured to send several TTIs of data to a BS. The apparatus 200 may be further configured to receive instructions from the BS on when to send all pilot symbols and when to reduce the pilot symbols for transmitted TTIs, and send pilot symbols according to the instructions. When the pilot symbols are instructed to be reduced, the apparatus 200 may be configured to send the pilot symbols only in every nth TTI, or to transmit reduced pilot patterns between every nth TTI.

The functionality described herein may be performed, at least in part, by one or more computer program product components such as software components. According to an embodiment, the apparatus 200 comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 200 may comprise means for performing at least one method described herein. In one example, the means comprises the at least one processor 202, the at least one memory 204 including instructions which, when executed by the at least one processor 202, cause the apparatus 200 to perform the method.

The apparatus 200 may comprise for example a computing device such as for example a base station, a network node, a server device, a client node, a mobile phone, a tablet computer, a laptop, or the like. In one example, the apparatus 200 may comprise a vehicle such as for example a car. Although the apparatus 200 is illustrated as a single device it is appreciated that, wherever applicable, functions of apparatus 200 may be distributed to a plurality of devices.

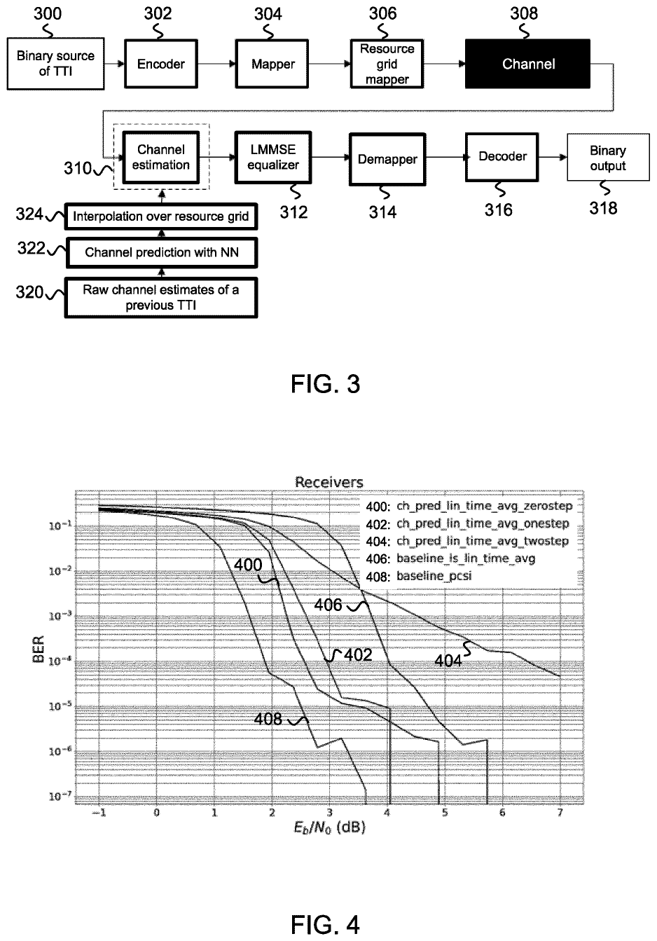

FIG. 3 illustrates an example of a communication system configured to perform channel predictions, according to an example embodiment. For example, the system of FIG. 3 may be used for uplink OFDM transmission from a user node, such as the UE 102, to a BS, such as the gNB 104. The channel predictions may be performed by the BS using a neural network.

At 300, bits from a binary source of a TTI may be received by the UE and fed to an encoder for mapping the input bits to coded bits at 302.

At 304, the output from the encoder may be provided to a mapper configured to map the coded bits to symbols. At 306, the symbols may be input to a resource grid mapper configured to map the symbols onto an OFDM resource grid. At 308, the mapped symbols may be transmitted over a channel. Operations from 300 to 308 may be performed by the UE.

At 310, the BS may perform a channel estimation based on pilot symbols comprised in the transmitted symbols. The BS may be further configured to perform the channel predictions for one or more subsequent TTIs with the neural network.

At 320, raw channel estimates of a previous TTI may be obtained. The neural network may be configured to have in its output layer as many units as the input vector and a linear activation function. For example, the raw channel estimate ĥ_{raw} of (2) may be first mapped to a real-valued vector via a complex-to-real mapping defined for a∈ [symbol] by {a [symbol] =(Re(a^{T}), Im(a^{T}))^{T}. Then, {ĥ_{raw} [symbol] may be given as input to the neural network. For example, the neural network may have one layer consisting of 2Nₚ neurons (or units) and the linear activation function. Hence, the neural network can be described by linear mapping {ĥ [symbol] =S{ĥ_{raw} [symbol] , where S∈ [symbol] is a matrix of weights, which is learned via training the neural network. The same neural network may be configured to operate separately on raw channel estimates obtained from two antenna inputs. However, the approach can also be extended to consider all antenna inputs jointly. The neural network could also be configured to process complex-valued inputs so that the complex-to-real mapping of ĥ_{raw} would not be needed.

After the raw channel estimates ĥ_{raw} are obtained from the Equation (2) and used as the input to the neural network to output a channel prediction at 322, the BS may be configured to interpolate or extrapolate the estimates ĥ from the output of the neural network to obtain predicted channel estimates over the whole TTI resource grid. Alternatively, interpolation can be carried out by the neural network at 324, wherein an output layer of the neural network is defined to have as many units as is needed for covering the whole resource grid of the TTI.

At 312, the output from the channel estimation (estimate or prediction) may be provided to a linear minimum mean square error (LMMSE) equalizer to minimize the mean squared error between the transmitted signal and an equalized received signal. At 314 the received signal may be demapped and then decoded at 316 to provide binary output data at 318. Operations from 310 to 318 may be performed by the BS.

Next, an implementation example of channel prediction performed with the communication system of FIG. 3 is provided. For example, the BS may have two antennas with dual cross type polarization and a predefined antenna pattern, such a radiation pattern defined in 3GPP technical report (TR) 38.901. The UE may comprise, for example, at least one antenna with a single V-type polarization and a same antenna pattern with the BS. Modulation used for the transmission may be, for example, 16-QAM.

The received bits may be encoded at 302, for example, with LDPC (low-density parity-check) coding with a code-rate of 0.5. The resource grid at 306 may comprise, for example, 14 OFDM symbols and 76 subcarriers with a subcarrier spacing of 30 kHz. The channel may be modelled at 308 using 3GPP CDL model C with a delay spread of 100 ns and UE speed of 10 m/s.

For channel estimation at 310, the channel response may be sampled for 14·(m+1) OFDM symbols for each Monte Carlo run, where m denotes how many slots forward the channel is predicted. The first 14 OFDM symbols of the sampled channel response may correspond to the TTI, whose raw channel estimates can be used to predict the channel for the last 14 OFDM symbols.

For example, the first TTI (first 14 OFDM symbols) may have pilot symbols at OFDM symbol indices 2 and 11. For the last TTI (last 14 OFDM symbols), for which the channel is predicted, no pilot symbols may be transmitted. Channel noise may be assumed to be zero-mean (circularly symmetric) complex Gaussian with known variance N₀, i.e., nᵢⱼ~ [symbol] (0,N₀) in Equation (1).

The neural network may be trained, for example, using randomized E_{b}/N₀ (energy per bit to noise power spectral density ratio) values over 1000 iterations and a batch size of 512. During the training phase, LDPC coding may be optional. Weights of the neural network may be trained by minimizing the binary cross-entropy loss between the true transmitted bits and the estimated log-likelihood ratios (produced by a demapper at 314) using the Adam optimizer.

FIG. 4 illustrates examples of evaluated bit error rates (BER) at 20 equally distributed E_{b}/N₀ values ranging from −1 dB to 7 dB obtained based on the implementation example and example baselines. The results are averaged over 100 iterations (of batch size 512) per E_{b}/N₀ value. The bit error rates illustrated in FIG. 4 comprise the following cases:

ch_pred_lin_time_avg_zerostep (400): neural network channel estimate of the current TTI (m=0). This corresponds to n=1, i.e., pilots sent at every TTI.

ch_pred_lin_time_avg_onestep (402): neural network channel prediction of the next TTI (m=1). This corresponds to n=2, i.e., pilots sent every other TTI.

ch_pred_lin_time_avg_twostep (404): neural network channel prediction of the further next TTI (m=2). This corresponds to n=3, i.e., pilots sent every third TTI.

baseline_ls_lin_time_avg (406): baseline results based on the raw channel estimates.

baseline_pcsi (408): baseline results based on perfect channel state information.

Each method except baseline_psci 408 interpolates the channel estimates from the pilot positions linearly over the resource grid and uses time averaging over the OFDM symbols. As noted above, for the channel prediction method described herein, the interpolation could have been incorporated to the neural network by increasing the number of neurons of the output layer.

The results given in FIG. 4 show that the channel could be predicted fairly well up to 2 TTIs forward. The neural network may be able to improve upon the raw channel estimates significantly. Notably, when E_{b}/N₀<3.5 dB, even the two-step prediction (ch_pred_lin_time_avg_twostep 404) outperformed the baseline_ls_lin_time_avg 406. The channel prediction method may be made more robust to varying channel conditions by training the neural network with more randomized parameters as well as by increasing its expressive power by using a different neural network architecture.

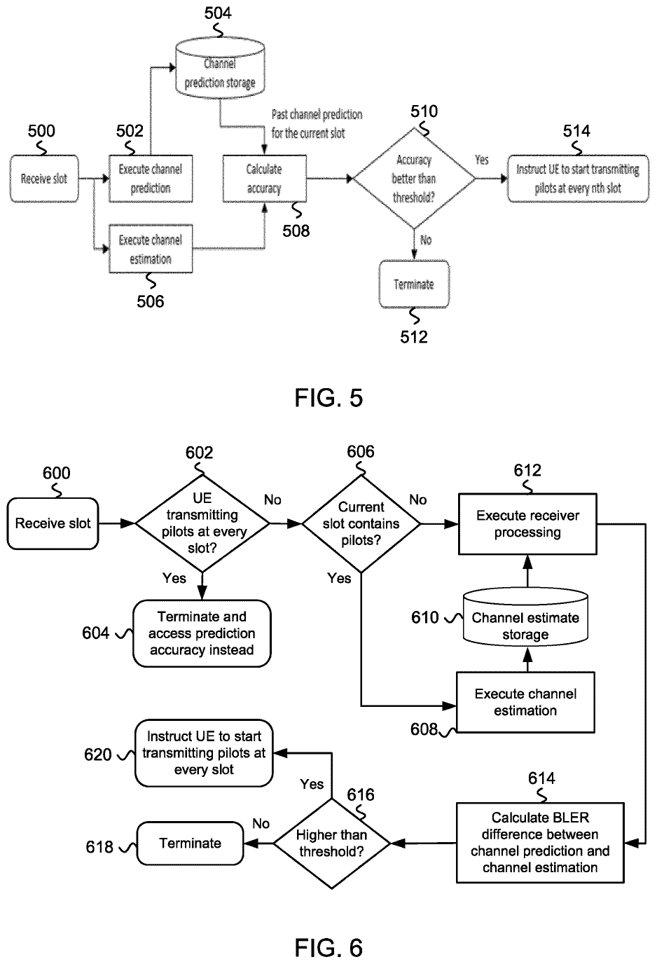

FIG. 5 illustrates an example flow chart for enabling reduction of reference signals based on channel predictions by a base station, according to an example embodiment. For example, pilot transmissions from a UE may be disabled or reduced when requested by the base station. This may enable reducing reference signal overhead caused by the pilot transmissions.

At 500, a network node, for example a BS such as the gNB 104, may be configured to receive a slot, i.e., a TTI, from a client node, such as the UE 102. The slot may comprise a set of pilot symbols. At 502, the BS may be configured to execute a channel prediction. For example, the BS may be configured to run the neural network-based channel prediction algorithm described in FIG. 3 for each slot received at 500. The BS may be configured to perform the predictions to estimate channels of one or more subsequent slots. At 504, the prediction result obtained at 502 may be stored by the BS at a storage for channel predictions. The storage may comprise, for example, an internal or external memory of the BS. At 506, the BS may be configured to execute channel estimation based on the received slot at 500.

At 508, the BS may be configured to calculate a channel prediction accuracy for the channel estimation of the current slot obtained at 506. The channel prediction accuracy may be calculated based on one or more past channel predictions determined based on previously received slots and stored in the channel prediction storage 504. At 510, the BS may be configured to determine if the channel prediction accuracy over the non-reduced pilot transmission interval n exceeds a predefined threshold. When the channel prediction accuracy is above the predefined threshold, the BS may be configured to request the UE to transmit pilots at every nth slot. This may enable to reduce RS overhead.

The request may be performed, for example, by adding an extra field in a scheduling grant transmitted over physical downlink control channel (PDCCH). The scheduling grant may be transmitter, for example, in a downlink control information (DCI) message. The request may be configured to indicate at which interval pilot-carrying slots should be transmitted. The request may comprise instructions for the UE to transmit the pilot-carrying slots, for example, at every 2^{nd} slot, or every 3^{rd} slot, or every 4^{th} slot, etc. The example intervals are only examples, and the BS may configure the UE to transmit the pilot-carrying slots at any interval, such as at an interval greater than every 4^{th} slot. Alternatively, the request may comprise instructions to send pilot symbols with a reduced pilot pattern, such as between every nth slot, where n is an integer greater than one.

When using the channel prediction method, it may be beneficial to track performance of the receiver. FIG. 6 illustrates an example flow chart for performing a corrective action based on tracked channel prediction accuracy by a base station, according to an example embodiment.

At 600, the BS may be configured to receive at least one slot/TTI transmitted by a UE. At 602, the BS may be configured to check if the UE is transmitting pilots at every slot, for example, based on a previously sent instructions to the UE. If yes, the BS may be configured at 604 to terminate the process for performance tracking and to access prediction accuracy instead as illustrated in FIG. 5. If no, the BS may be configured to check at 606 if the current slot contains pilots.

When the current slot contains a set of pilot symbols, the BS may be configured to execute channel estimation based on the pilot symbols at 608. At 610, the channel estimation may be stored by the BS to a channel estimate storage. When the current slot does not contain pilot symbols, or only reduced pilot symbols, the process proceeds to 612. At 612, the BS may be configured to execute receiver processing of the current slot based on a channel prediction for the slot or the channel estimates stored at 610.

At 614, the BS may be configured to calculate a block error rate (BLER) difference using channel prediction and channel estimation. The BS may be configured to constantly compare the BLER of the pilot-carrying slots to those demodulated using a predicted channel. At 616, the BS may be configured to compare the BLER difference to a predefined threshold. If the BLER difference exceeds the predefined threshold, this may indicate that the channel conditions are no more favourable for using the prediction. When the BLER difference is above the predefined threshold, the BS may be configured to instruct at 620 the UE to start again transmitting all pilot symbols at every slot. The threshold can be defined and calculated based on an expected throughput, taking into account the reduced pilot overhead which may allow for a higher BLER. When the comparison performed at 616 indicates that the BLER difference is below the predefined threshold, the process may be terminated, for example, until a next slot is received.

A rule for switching to transmitting pilot symbols only at every nth slot can be formulated, for example, as follows. Let Aₙ=(1−BLERₙ)∈[0,1], where BLERₙ denotes an average block error rate when using a pilot transmission interval of n TTIs. That is, with n=1, pilot symbols are transmitted at every slot, and with n=2, pilot symbols are transmitted at every other slot. Let

$${B}_{n} = ( 1 - \frac{{N}_{p}}{{nN}_{FFT} {N}_{OFDM}} ) ,$$

where N_{FFT} is a number of subcarriers, N_{OFDM} is a number of OFDM symbols in a slot, and Nₚ is a number of pilot symbols in every nth slot. Hence, Bₙ is the average proportion of data carrying resource elements of the resource grid, when transmitting pilot symbols only at every nth slot. In the case, when transmitting reduced pilots between every nth slot, the equation for Bₙ has to be modified accordingly to represent the average proportion of data carrying resource elements in the resource grid. The goal is to maximize the product AₙBₙ for n≥1. From currently transmitting pilots at every nth slot, switching to transmitting pilot symbols at every kth slot may be configured to be done if AₖBₖ≥AₙBₙ, which is equivalent to the criteria

$${BLER}_{k} - {BLER}_{n} \leq {A}_{n} ( 1 - \frac{{B}_{n}}{{B}_{k}} ) . \qquad ( 3 )$$

For example, if pilot symbols were transmitted at every slot, the BS may be configured to instruct the UE to switch to transmitting the pilot symbols at every second slot if Equation (3) is satisfied for (n=1, k=2). Reducing the pilot transmission interval can be done incrementally in steps, or by directly reverting back to transmitting pilot symbols at every slot.

Alternatively, instead of using a certain threshold for the difference of the BLERs, it would also be possible to set a threshold for the error between the predicted channel coefficients and the current (estimated) channel coefficients. For example, the BS may be configured to determine a distance measure between the predicted and estimated coefficients and the threshold may be set for the distance measure.

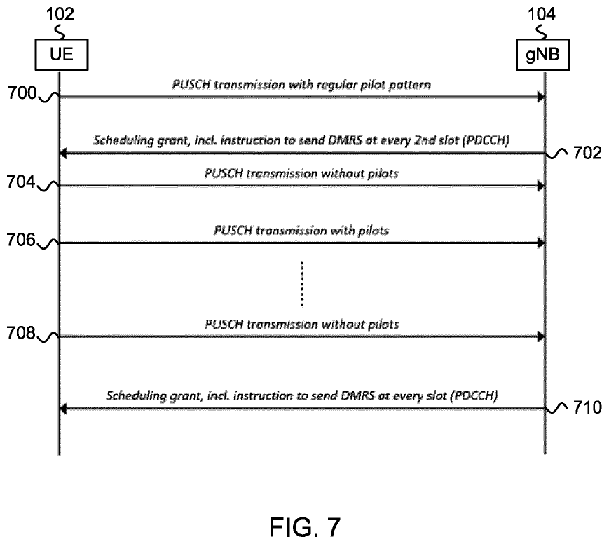

FIG. 7 illustrates an example of a message sequence chart between a client node and a base station for reduction of reference signals according to an example embodiment. FIG. 7 illustrates a scenario where the base station, such as gNB, identifies that channel prediction can be used, and instructs the client node, such as UE, to transmit all pilot symbols only at every 2^{nd} slot. Then, once a BLER degradation is detected by the gNB, the UE may be instructed to again transmit all pilot symbols at every slot.

At 700, the UE may perform a physical uplink shared channel (PUSCH) transmission with regular pilot pattern. Once the gNB receives the transmission, the gNB may be configured to determine if criteria for sending pilots at some interval, such as at every 2^{nd} slot, is satisfied.

At 702, the gNB may be configured to send a scheduling grant to the UE. The scheduling grant may comprise instructions to send demodulation reference signals, i.e., pilot symbols, at the interval determined by the gNB. The scheduling grant may be sent by the gNB to the UE via PDCCH.

At 704, the UE may be configured to send a PUSCH transmission comprising a first slot without pilot symbols and at 706 a PUSCH transmission comprising a second slot with pilot symbols, according to the instructions received from the gNB at 702. The UE may continue to transmit the pilot symbols at every second slot, and to transmit every other slot without the pilot symbols, until instructed otherwise by the gNB. The gNB may be configured to demodulate the first slot based on predicted channel from a memory. The gNB may be configured to demodulate the second slot based on a channel estimate and to store a predicted channel to the memory.

At 708, a PUSCH transmission without pilot symbols is received by the gNB from the UE, and the gNB may detect based on the received transmission that a BLER difference between channel prediction and channel estimation exceeds a predefined threshold. After detecting that the threshold is exceeded, the gNB may be configured to send a second scheduling grant to the UE, wherein the scheduling grant comprises instructions for the UE to send the DMRS at every slot.

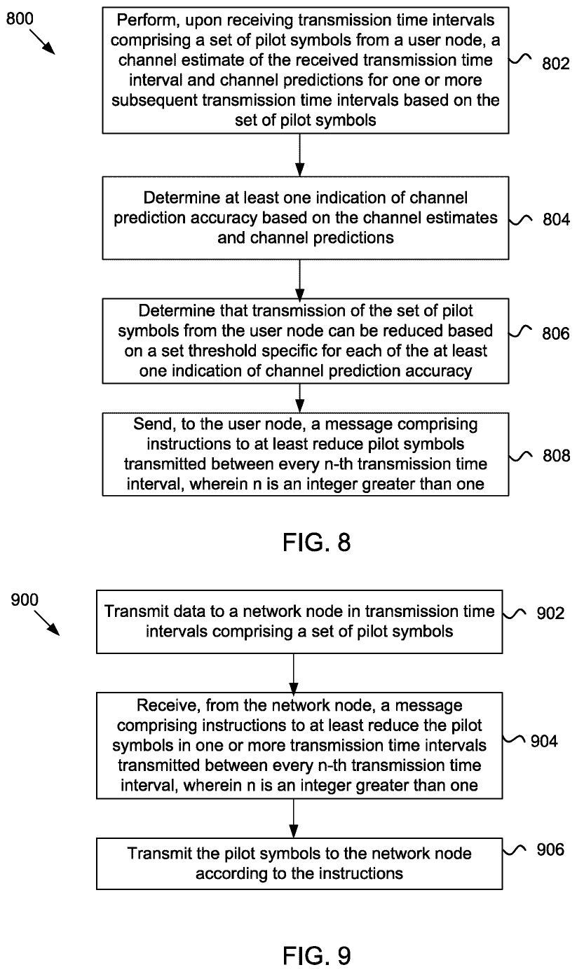

FIG. 8 illustrates an example of a method 800 for managing reduction of reference signals to be sent by a user node, according to an example embodiment. The method may be performed, for example, by a network node such as a gNB.

At 802, the method may comprise performing, upon receiving transmission time intervals comprising a set of pilot symbols from the user node, a channel estimate of the received transmission time interval and channel predictions for one or more subsequent transmission time intervals based on the set of pilot symbols.

At 804, the method may comprise determining at least one indication of channel prediction accuracy based on the channel estimates and channel predictions.

At 806, the method may comprise determining that transmission of the set of pilot symbols from the user node can be reduced based on the at least one indication of channel prediction accuracy. The at least indication of one channel prediction accuracy may be compared to a specific threshold set for the indication to determine when the pilot transmissions can be reduced.

At 808, the method may comprise sending, to the user node, a message comprising instructions to at least reduce pilot symbols transmitted between every nth transmission time interval, wherein n is an integer greater than one.

FIG. 9 illustrates an example of a method 900 for reducing reference signals sent by a user node, according to an example embodiment. The method may be performed, for example, by a user node such as UE.

At 902, the method may comprise transmitting data to a network node in transmission time intervals comprising a set of pilot symbols.

At 904, the method may comprise receiving, from the network node, a message comprising instructions to at least reduce the pilot symbols in one or more transmission time intervals transmitted between every nth transmission time interval, wherein n is an integer greater than one.

At 906, the method may comprise transmitting the pilot symbols to the network node according to the instructions.

Further features of the methods directly result from the functionalities and parameters of the apparatuses, as described in the appended claims and throughout the specification and are therefore not repeated here. It is noted that one or more operations of the method may be performed in different order.

An apparatus, for example a network node, a user node or a client node, may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at one memory and the program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including instructions which, when executed by the at least one processor, cause the apparatus at least to:
perform, upon receiving transmission time intervals comprising a set of pilot symbols from a user equipment, a channel estimate of the received transmission time interval and channel predictions for one or more subsequent transmission time intervals based on the set of pilot symbols;
determine at least one indication of channel prediction accuracy based on the channel estimates and channel predictions;
determine that transmission of the set of pilot symbols from the user equipment can be reduced based on a set threshold specific for each of the at least one indication of channel prediction accuracy; and
send, to the user equipment, a message comprising instructions to at least reduce pilot symbols transmitted between every nth transmission time interval, wherein n is an integer greater than one.

2. The apparatus of claim 1, wherein the message comprises instructions to disable transmission of the set of pilot symbols between every n th transmission time interval or to transmit reduced pilot patterns between every n th transmission time interval.

3. The apparatus of claim 1, wherein the instructions are sent in a downlink control information message for scheduling grant.

4. The apparatus of claim 1, wherein the at least one memory further includes instructions which, when executed by the at least one processor, cause the apparatus to:
monitor the at least one indication of channel prediction accuracy after sending the message to the user equipment;
detect degradation in the channel prediction accuracy based on a comparison of the channel estimation and the channel prediction of a current transmission time interval;
send, to the user equipment, a message comprising instructions to transmit the set of pilot symbols during each transmission time interval.

5. The apparatus of claim 1, wherein the integer n is determined based on the at least one indication of prediction accuracy of the one or more subsequent transmission time intervals.

6. The apparatus of claim 1, wherein the at least one memory comprises instructions which, when executed by the at least one processor, cause the apparatus to:
obtain a raw channel estimate based on the set of received pilot symbols in a transmission time interval for input to a neural network trained for channel predictions;
obtain the channel predictions for the one or more subsequent transmission time intervals based on an output from the neural network; and
perform interpolation or extrapolation on the output to estimate the channel for the one or more subsequent transmission time intervals over a resource grid.

7. The apparatus of claim 1, wherein the at least one memory comprises instructions which, when executed by the at least one processor, cause the apparatus to:
perform demodulation based on the channel estimate for every n th received transmission time interval comprising the set of pilot symbols; and
perform demodulation based on the channel prediction for the one or more transmission time intervals received between every nth transmission time interval.

8. The apparatus of any of claim 4, wherein the at least one memory further comprises instructions which, when executed by the at least one processor, cause the apparatus to:
calculate a block error rate of a received nth transmission time interval comprising the set of pilot symbols based on the channel estimation;
calculate a block error rate of a transmission time interval received between every nth transmission time interval based on the channel prediction; and
send the message comprising instructions to send the set of pilot symbols in each transmission time interval when a difference between the block error rates exceeds the threshold set for the difference.

9. The apparatus of claim 1, wherein the at least one memory comprises instructions which, when executed by the at least one processor, cause the apparatus to:
obtain coefficients of the channel prediction and coefficients of the channel estimate of the current transmission time interval; and
send the message comprising instructions to reduce the pilot symbols or to send pilot symbols in each transmission time interval based on a distance measure between the estimated and predicted coefficients and the threshold set for the distance measure.

10. An apparatus, comprising:
at least one processor; and
at least one memory including instructions which, when executed by the at least one processor, cause the apparatus at least to:
transmit data to a network node in transmission time intervals comprising a set of pilot symbols;
receive, from a network node, a message comprising instructions to at least reduce the number of pilot symbols in one or more transmission time intervals transmitted between every nth transmission time interval, wherein n is an integer greater than one; and
transmit the pilot symbols to the network node according to the instructions.

11. The apparatus of claim 10, wherein the instructions comprise to disable transmission of the pilot symbols between every n th transmission time interval or to transmit reduced pilot patterns between every n th transmission time interval.

12. The apparatus of claim 10, wherein the at
least one memory further comprises instructions which, when executed by the at least one processor, cause the apparatus to:
receive, from the network node, a message comprising instructions to transmit the set of pilot symbols in every transmission time interval; and
transmit the set of pilot symbols to the network node according to the latest instructions.

13. The apparatus of claim 10, wherein the instructions are sent in a downlink control information message for scheduling grant.

14. (canceled)

15. A computer-implemented method, comprising:
transmitting data to a network node in transmission time intervals comprising a set of pilot symbols;
receiving, from a network node, a message comprising instructions to at least reduce the number of pilot symbols in one or more transmission time intervals transmitted between every nth transmission time interval, wherein n is an integer greater than one; and
transmitting the pilot symbols to the network node according to the instructions.

16. The method of claim 15, wherein the instructions comprise to disable transmission of the pilot symbols between every n th transmission time interval or to transmit reduced pilot patterns between every n th transmission time interval.

17. The method of claim 15, further comprising:
receiving, from the network node, a message comprising instructions to transmit the set of pilot symbols in every transmission time interval; and
transmitting the set of pilot symbols to the network node according to the latest instructions.

18. The method of claim 15, wherein the instructions are sent in a downlink control information message for scheduling grant.
